(19) United States
(12) Patent Application Publication
(10) Pub. No.: US 2026/0289297 A1
(43) Pub. Date: Sep. 24, 2026

(54) INFORMATION PROCESSING DEVICE, INFORMATION PROCESSING METHOD, AND RECORD MEDIUM RECORDING INFORMATION PROCESSING PROGRAM

(71) Applicant: Mitsubishi Electric Corporation, Tokyo (JP)

(72) Inventor: Kenya NAKAI, Tokyo (JP)

(73) Assignee: Mitsubishi Electric Corporation, Tokyo (JP)

(21) Appl. No.: 19/475,474

(22) PCT Filed: Apr. 27, 2023
(86) PCT No.: PCT/JP2023/016585

§ 371 Date: Oct. 15, 2025

(51) Int. Cl. G06N 3/08; G06N 3/044

(52) U.S. Cl. CPC G06N 3/08; G06N 3/044

(57) ABSTRACT

An information processing device includes a neural network including an input layer, a physical reservoir layer as an intermediate layer, and an output layer, an action-imparting unit to impart an action to the physical reservoir layer, thereby causing a change corresponding to the action to an internal connection state of the physical reservoir layer, an adjustment unit to adjust weight coefficients of the output layer based on an output value of the output layer, and a control unit to control operation of the action-imparting unit.

### TECHNICAL FIELD

The present disclosure relates to an information processing device, an information processing method, and an information processing program.

### BACKGROUND ART

There has been proposed a computing technology that is called reservoir computing as one of hierarchical or interconnected neural networks. In the reservoir computing, the computational load can be reduced by replacing a recurrent neural network with a reservoir layer, setting a weight coefficient of the reservoir layer at a fixed value, and executing the learning only in an output layer.

Further, there has also been proposed a computing technology called physical reservoir computing that realizes highly sophisticated processing such as data classification or time-series prediction regarding the input to an input layer by forming the reservoir layer with a physical reservoir layer (e.g., a physical property material, an optical waveguide or the like) and executing a small amount of learning computation in the output layer (see Patent References 1 to 3, for example).

### PRIOR ART REFERENCE

### Patent Reference

Patent Reference 1: Japanese Patent No. 6,701,247

Patent Reference 2: Japanese Patent No. 7,108,987

Patent Reference 3: Japanese Patent Application Publication No. 2022-80891

### SUMMARY OF THE INVENTION

### Problem to be Solved by the Invention

However, in the physical reservoir computing in the present condition, there is a problem in that it is impossible to switch the inference target since the weight coefficient of the physical reservoir layer is fixed.

An object of the present disclosure is to provide an information processing device, an information processing method and an information processing program with which the switching of the inference target is possible.

### Means for Solving the Problem

An information processing device in the present disclosure includes a neural network including an input layer, a physical reservoir layer as an intermediate layer, and an output layer; an action-imparting unit to impart an action to the physical reservoir layer, thereby causing a change corresponding to the action to an internal connection state of the physical reservoir layer; an adjustment unit to adjust weight coefficients of the output layer based on an output value of the output layer; and a control unit to control operation of the action-imparting unit.

An information processing method in the present disclosure is a method to be executed by an information processing device that includes a neural network including an input layer, a physical reservoir layer as an intermediate layer, and an output layer; and an action-imparting unit to impart an action to the physical reservoir layer. The information processing method includes a step of adjusting weight coefficients of the output layer based on an output value of the output layer; and a step of making the action-imparting unit impart an action to the physical reservoir layer, thereby causing a change corresponding to the action to an internal connection state of the physical reservoir layer.

### Effect of the Invention

According to the present disclosure, the inference target can be switched by changing the internal connection state of the physical reservoir layer.

### BRIEF DESCRIPTION OF THE DRAWINGS

FIG. 1 is a functional block diagram showing the configuration of an information processing device (learning device) according to a first embodiment.

FIG. 2 is a diagram showing an example of the hardware configuration of the information processing device (learning device) according to the first embodiment.

FIG. 3 is a schematic diagram indicating that the state of a neural network in a physical reservoir layer changes due to an action.

FIG. 4 is a schematic diagram indicating that the state of the neural network in the physical reservoir layer changes due to a mechanical action (external force).

FIGS. 5A and 5B are schematic diagrams indicating that the state of the neural network of the physical reservoir layer changes due to an optical action (light pattern).

FIGS. 6A and 6B are schematic diagrams indicating that the state of the neural network in the physical reservoir layer changes due to a magnetic action (magnetic flux).

FIG. 7 is a flowchart showing a learning process of the information processing device (learning device) according to the first embodiment.

FIG. 8 is a functional block diagram showing the configuration of an information processing device (inference device) according to the first embodiment.

FIG. 9 is a diagram showing an example of the hardware configuration of the information processing device (inference device) according to the first embodiment.

FIG. 10 is a flowchart showing an inference process of the information processing device (inference device) according to the first embodiment.

FIG. 11 is a functional block diagram showing another configuration of the information processing device (inference device) according to the first embodiment.

FIG. 12 is a functional block diagram showing the configuration of an information processing device (learning device) according to a second embodiment.

FIG. 13 is a flowchart showing the learning process of the information processing device (learning device) according to the second embodiment.

FIG. 14 is a functional block diagram showing the configuration of an information processing device (inference device) according to the second embodiment.

FIG. 15 is a flowchart showing the inference process of the information processing device (inference device) according to the second embodiment.

FIG. 16 is a functional block diagram showing another configuration of the information processing device (inference device) according to the second embodiment.

### MODE FOR CARRYING OUT THE INVENTION

An information processing device, an information processing method and an information processing program according to each embodiment will be described below with reference to the drawings. The following embodiments are just examples and it is possible to appropriately combine embodiments and appropriately modify each embodiment. In the drawings, the same components or components having the same function are assigned the same reference character.

### FIRST EMBODIMENT

A first embodiment relates to an information processing device that makes it possible to switch the neural network for a different learning object by changing an internal connection state of a certain physical reservoir layer.

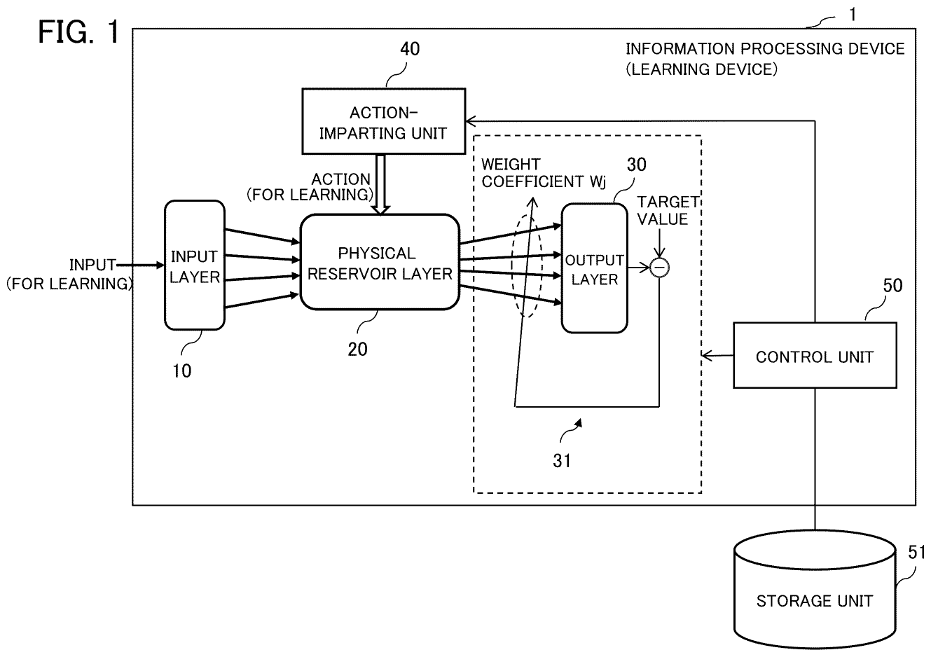

FIG. 1 is a functional block diagram showing the configuration of an information processing device 1 (learning device) according to the first embodiment. The information processing device 1 is a device capable of executing an information processing method (learning method) according to the first embodiment. A control unit 50 (learning control unit) of the information processing device 1 is a computer, for example.

The information processing device 1 includes a neural network that includes an input layer 10, a physical reservoir layer 20 as an intermediate layer, and an output layer 30, an action-imparting unit 40 that imparts an action to the physical reservoir layer 20, thereby causing a change corresponding to the imparted action to the internal connection state of the physical reservoir layer 20, an adjustment unit 31 that adjusts weight coefficients Wj (j: positive integer assigned to each of a plurality of weight coefficients) of the output layer 30 based on an output value of the output layer 30, and the control unit 50 that controls the operation of the action-imparting unit 40. The information processing device 1 is connected to a storage unit 51 as a storage device for storing information. The storage unit 51 can also be a part of the information processing device 1.

In the first embodiment, the weight coefficients Wj of the output layer 30 are updated so that a desired inference result (e.g., output value closest to a target value) is obtained in each neural network as the result of the switching by changing the action (i.e., in each of a plurality of actions).

The control unit 50 generates a learning model, for inferring the output value as the inference result from input information regarding the inference target inputted to the input layer 10, by using learning data including learning input data inputted to the input layer 10 and a target value as learning training data. The control unit 50 stores the weight coefficients Wj for each of the plurality of actions in the storage unit 51 as parameters of the learning model.

Physical reservoir computing by use of a physical reservoir layer is described in the following Non-patent References 1 and 2, for example:

Non-patent Reference 1: Gouhei Tanaka, “ (Keywords You Should Know No. 136) Reservoir Computing”, The Journal of the Institute of Image Information and Television Engineers, Vol. 74, No. 3, pp. 532-534, 2020 .

https://www.ite.or.jp/contents/keywords/2005keyword.pdf

Non-patent Reference 2: Toshiyuki Yamane, “Machine Learning Device by Physical Reservoir Computing and Application to Edge Computing”, ProVISON No. 95, pp.61-65 (Technical Description 5), 2019.

https://www.ibm.com/downloads/cas/8MZNZZGX

The physical reservoir layer 20 assumes the role of converting information supplied from the input layer 10 to high-dimensional information according to intrinsic non-linear characteristics of its material and structure, and is represented by a recurrent neural network for time-series data. The neural network is dependent on the internal connection state as the state of connection between virtual nodes in the physical reservoir layer 20.

In the first embodiment, the internal connection state as the state of connection between virtual nodes existing in the material bearing the physical reservoir layer 20 and its structure is not fixed but changed (e.g., updated) in a proactive manner. By making the action-imparting unit 40 impart an action to the whole or a part of the physical reservoir layer 20, it is possible to change a non-linear characteristic (i.e., non-linear dynamics) due to deformation, a change of state, or the like of the material bearing the physical reservoir layer 20 and the structure of the physical reservoir layer 20. In other words, a processing task of the information processing device 1 including the physical reservoir layer 20 can be switched by changing the action imparted to the physical reservoir layer 20.

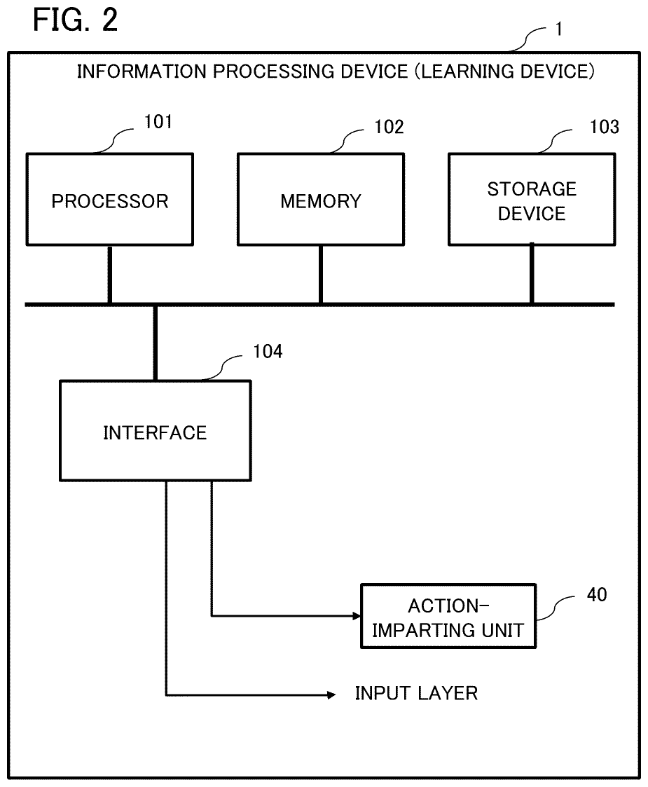

FIG. 2 is a diagram showing an example of the hardware configuration of the information processing device 1 (learning device) according to the first embodiment. The information processing device 1 according to the first embodiment includes a processor 101 such as a CPU (Central Processing Unit), a memory 102 as a storage device such as a RAM (Random Access Memory), a storage device 103 as a nonvolatile storage device such as an HDD (Hard Disk Drive) or an SSD (Solid State Drive), and an interface 104. These components correspond to the control unit 50 and the storage unit 51 in FIG. 1. These components may also be formed with dedicated processing circuitry.

The processor 101 is capable of executing an information processing program according to the first embodiment. The information processing program is acquired, for example, in the form of having been recorded in a record medium such as an SD (Secure Digital) memory card or a USB (Universal Serial Bus) memory card, or by means of downloading via a network. The hardware configuration shown in FIG. 2 is just an example and a variety of modifications of the hardware configuration are possible.

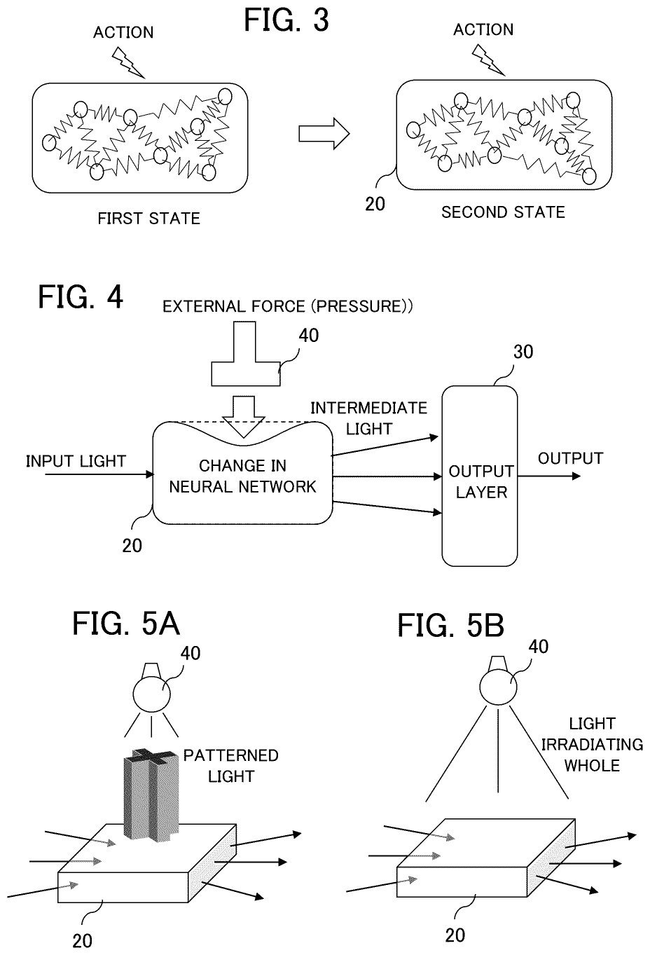

FIG. 3 is a schematic diagram indicating that the state of the neural network in the physical reservoir layer 20 changes due to the action. By imparting the action by the action-imparting unit 40 to the whole or a part of an action-receiving surface of the physical reservoir layer 20, the internal connection state of the physical reservoir layer 20 can be changed. Further, it is possible to employ a physical reservoir layer 20 in which the internal connection state of the physical reservoir layer 20 when the action by the action-imparting unit 40 is imparted to the whole of the action-receiving surface of the physical reservoir layer 20 differs from the internal connection state of the physical reservoir layer 20 when the action by the action-imparting unit 40 is imparted to a part of the action-receiving surface (e.g., half region, ¼ region, circular region, quadrangular region, triangular region, or the like) of the physical reservoir layer 20. It is also possible to employ a physical reservoir layer 20 in which the internal connection state varies depending on the shape, area or the like of the action-receiving surface's region to which the action is imparted (e.g., half region, ¼ region, circular region, quadrangular region, triangular region, or the like), for example, in cases where the action is unnecessary for a part of the action-receiving surface of the physical reservoir layer 20. The action includes at least one factor out of light, electricity, magnetism, heat, external force and a chemical substance imparted (applied) to the physical reservoir layer 20.

FIG. 4 is a schematic diagram indicating that the state of the neural network in the physical reservoir layer 20 changes due to a mechanical action (external force).

FIGS. 5A and 5B are schematic diagrams indicating that the state of the neural network formed by the physical reservoir layer 20 changes due to an optical action (light pattern). In the example in FIGS. 5A and 5B, the action-imparting unit 40 is a light irradiation device that irradiates the physical reservoir layer 20 with light. In FIG. 5A, it is possible to apply patterned light to a partial region of the physical reservoir layer 20 and make the internal connection state vary depending on the physical reservoir layer 20's region to which the action (light pattern) is imparted. That is, in FIG. 5A, the internal connection state of a region irradiated with the patterned light differs from the internal connection state of a region not irradiated with the patterned light. The patterned light can be generated by using an optical element whose partial region has an optical filter characteristic of letting through, reflecting or absorbing light from a light source. Alternatively, the patterned light can be generated by using a spatial light modulation element capable of dynamically switching the light transmission/reflection/absorption characteristic. The physical reservoir layer 20 can also be a layer that transforms the input light to intermediate light being speckle light by repeating scattering and diffusion of light inside the layer. The input light to the physical reservoir layer 20 can also be speckle light. This is because the interference pattern of the speckle light has a characteristic of sensitively varying depending on interference condition.

Further, the physical system of the physical reservoir layer 20 can also be a system that contains molecules or particles as contained materials inside the system and forms a neural network optically connected by the contained materials.

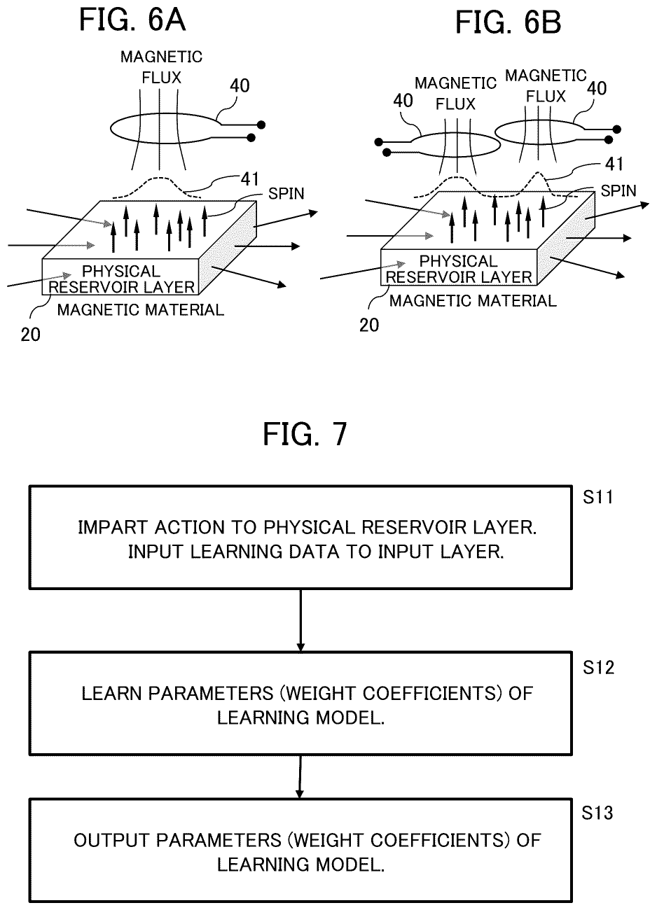

FIGS. 6A and 6B are schematic diagrams indicating that the state of the neural network in the physical reservoir layer 20 changes due to a magnetic action (magnetic flux). In the example in FIGS. 6A and 6B, the action-imparting unit 40 is a coil as a magnetic flux imparting unit that generates magnetic flux (e.g., magnetic flux density distribution pattern 41) to be imparted (applied) to the physical reservoir layer 20. FIG. 6B shows an example of changing the state of the neural network formed by the physical reservoir layer 20 by using the magnetic flux density distribution pattern that provides the magnetic flux density distribution with a bias or a region where the magnetic flux density is partially high or low (i.e., patterned magnetic flux density), similarly to the case of the optical action in FIG. 5A. That is, the internal connection state of a region where the magnetic flux is strong differs from the internal connection state of a region where the magnetic flux is weak. The number of coils for imparting the magnetic flux density distribution pattern can also be three or more.

Examples of the action imparted to the physical reservoir layer 20 of the information processing device 1 in the first embodiment will be shown below. As mechanical actions, there are pressure, deformation, torsional distortion, and so forth. As optical actions, there are light intensity, a wavelength, light plasma, and so forth. As electric actions, there are an electric field, electric current, voltage, an electric charge, and so forth. As thermal actions, there are heat absorption, heating, cooling, and so forth. As magnetic actions, there are a magnetic field, magnetic force, and so forth. As chemical actions, there are liquid molecules, gas molecules, and so forth.

FIG. 7 is a flowchart showing a learning process of the information processing device 1 (learning device) according to the first embodiment. In the learning process of the information processing device 1, an action is imparted to the physical reservoir layer 20 and the learning data is inputted to the input layer 10 (step S11), the weight coefficients Wj are learned as parameters of the learning model (step S12), and the weight coefficients as the parameters are outputted (step S13). The outputted weight coefficients Wj are stored in the storage unit 51.

Further, there are cases where a learning model is used for magnifying the difference between two patterns that are difficult to distinguish from each other and transforming the two patterns to patterns easily distinguishable from each other. In such cases, it is possible to generate a learning model capable of determining whether inputted patterns are the same or not based on first and second actions by determining the weight coefficients as the parameters of the learning model by executing the learning while changing the weight coefficients, thereafter imparting an action to the physical reservoir layer 20 and acquiring the first action that causes a first target value to be inferred for a first inference target, imparting another action to the physical reservoir layer 20 and acquiring the second action that causes a second target value to be obtained for a second inference target.

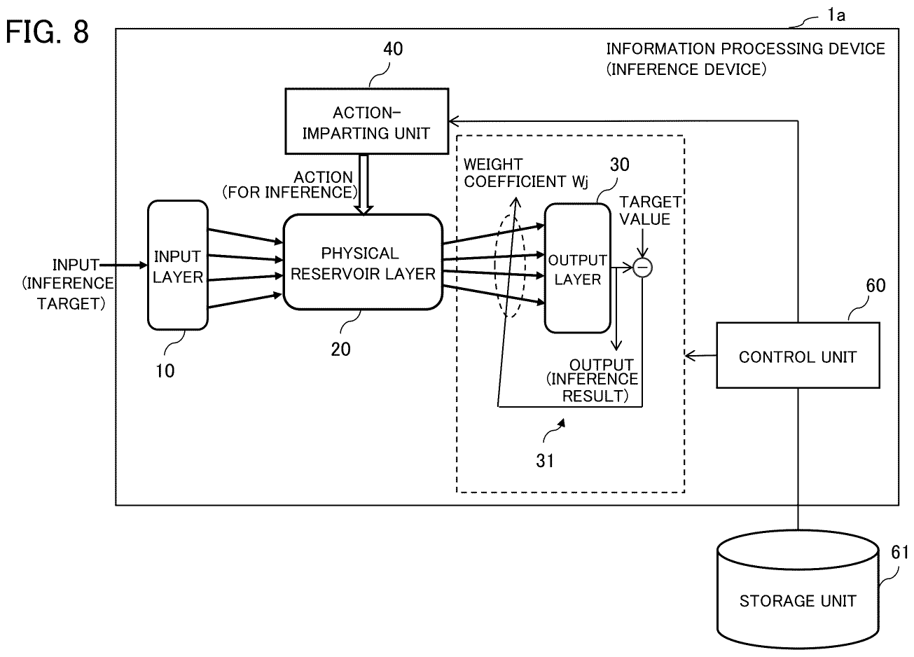

FIG. 8 is a functional block diagram showing the configuration of an information processing device 1a (inference device) according to the first embodiment. The information processing device 1a is a device capable of executing an information processing method (inference method) according to the first embodiment. A control unit 60 (inference control unit) of the information processing device 1a is a computer, for example. The control unit 60 of the information processing device la infers an output value as an inference result outputted from the output layer 30 from the input information regarding the inference target inputted to the input layer 10 by using the learning model corresponding to the action imparted by the action-imparting unit 40. While a storage unit 61 stores the learning model in the storage unit 51 in FIG. 1, the storage unit 61 can be the same unit as the storage unit 51.

Further, the control unit 60 may also select a learning model corresponding to the action imparted by the action-imparting unit 40 from learning models for inferring the output value from the input information inputted to the input layer 10 generated by a learning device that uses learning data including learning input data and learning training data and infer the output value as the inference result outputted from the output layer 30 from the input information regarding the inference target inputted to the input layer 10 by using the selected learning model. In this case, the information processing device 1a is a learning-inference device.

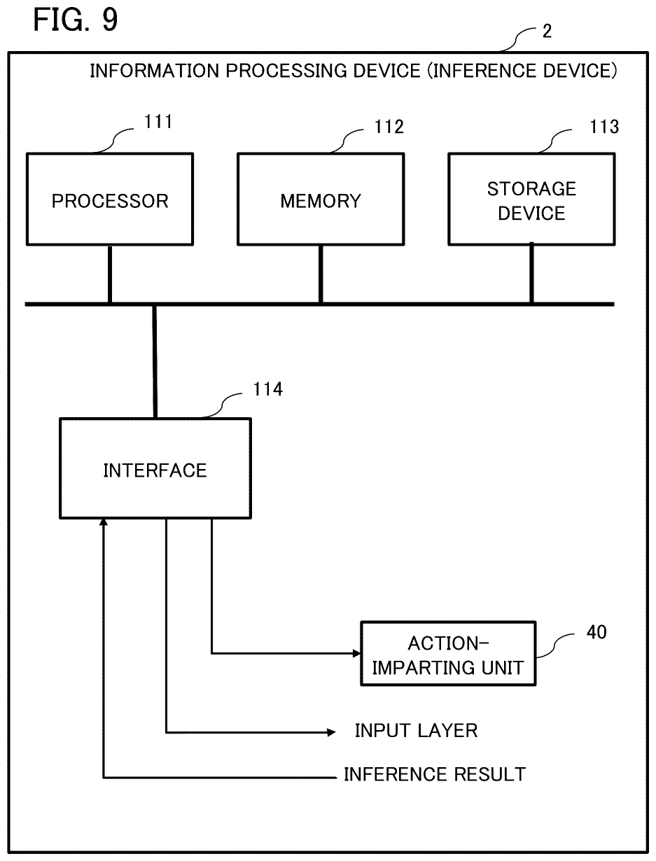

FIG. 9 is a diagram showing an example of the hardware configuration of the information processing device 1a (inference device) according to the first embodiment. The information processing device 1a according to the first embodiment includes a processor 111 such as a CPU, a memory 112 as a storage device such as a RAM, a storage device 113 as a nonvolatile storage device such as an HDD or an SSD, and an interface 114. These components correspond to the control unit 60 and the storage unit 61 in FIG. 8. These components may also be formed with dedicated processing circuitry.

The processor 111 is capable of executing an information processing program according to the first embodiment. The information processing program is acquired, for example, in the form of having been recorded in a record medium such as an SD memory card or a USB memory card, or by means of downloading via a network. The hardware configuration shown in FIG. 9 is just an example and a variety of modifications of the hardware configuration are possible.

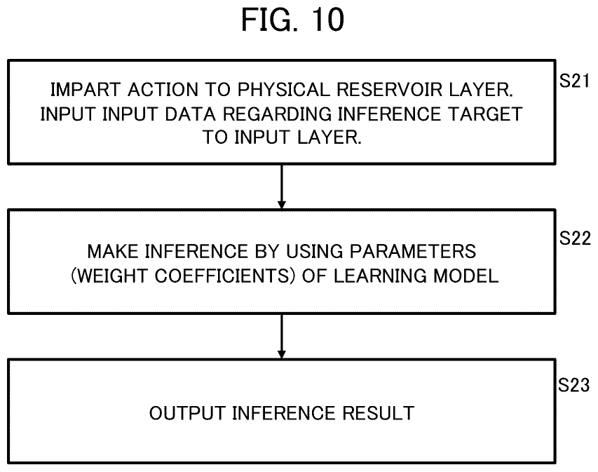

FIG. 10 is a flowchart showing an inference process of the information processing device 1a (inference device) according to the first embodiment. In the inference process of the information processing device 1, an action is imparted to the physical reservoir layer 20 and input data regarding the inference target is inputted to the input layer 10 (step S21), the inference is made by using the parameters (weight coefficients) of the learning model (step S22), and the inference result is outputted (step S23).

Further, in cases of identifying the difference between two patterns that are difficult to distinguish from each other, the control unit 60 first switches the inference to a first inference target, loads a condition that reproduces a first action state, imparts the first action state to the physical reservoir layer, and executes the inference. Subsequently, the control unit 60 may switch the inference to a second inference target, load a condition that reproduces a second action state, impart the second action state to the physical reservoir layer, execute the inference, and make the determination based on the two inference results.

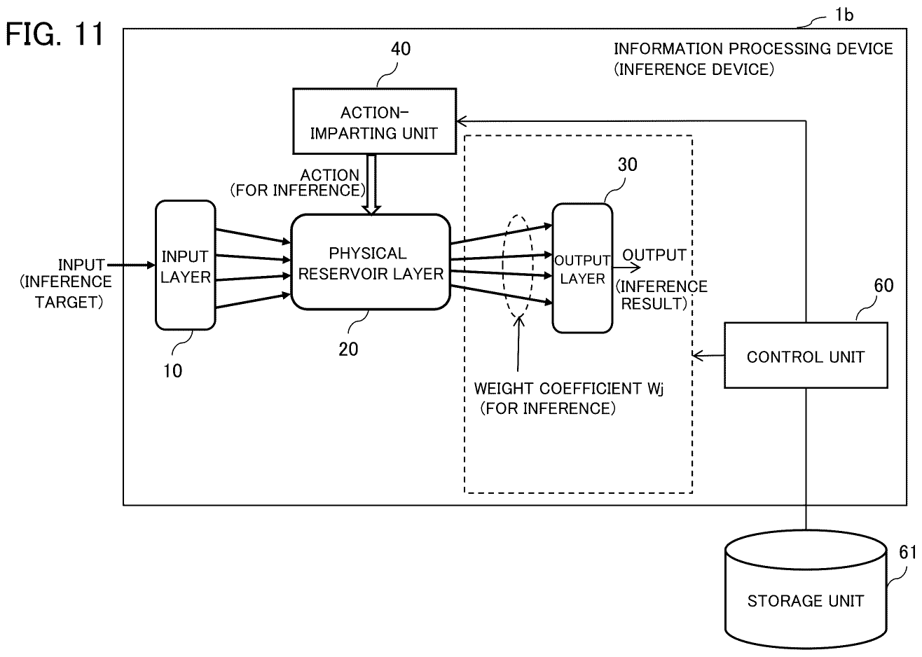

FIG. 11 is a functional block diagram showing another configuration of an information processing device 1b (inference device) according to the first embodiment. The information processing device 1b is a device capable of executing an information processing method (inference method) according to the first embodiment. The control unit 60 (inference device) of the information processing device 1b is a computer, for example. The control unit 60 is capable of making the inference based on the learning model by using the aforementioned input information and the output value, without the need of updating the weight coefficients Wj of the output layer 30 so that an output value closest to a target value is obtained.

As described above, with the information processing devices 1, 1a and 1b based on the physical reservoir computing, it becomes possible to deal with various learning processes and inference processes by changing the action. Further, with the information processing devices 1, 1a and 1b, high-sensitivity sensing based on the physical reservoir computing becomes possible.

### SECOND EMBODIMENT

A second embodiment relates to an information processing device that makes it possible to switch the neural network for a different learning object by making a change in the internal connection state of a certain physical reservoir layer 20 and infer a feature quantity that makes a change in the internal connection state of the physical reservoir layer 20 from the change in the weight coefficients of the output layer updated so that a desired inference result is obtained via the neural network. In the second embodiment, usage different from the concept of the conventional physical reservoir computing is employed as described below.

Differently from the first embodiment, in the second embodiment, the internal connection state as the state of connection of virtual nodes in the neural network is changed by imparting an action to the physical reservoir layer 20, and the mode of the action is inferred from the change in the weight coefficients Wj of the output layer 30 after the learning caused by the change of the internal connection state. Put another way, in the second embodiment, the action imparted to the physical reservoir layer 20 is the input information as the inference target, and the output data based on the weight coefficients Wj is the inference result.

Further, in the second embodiment, it is generally common that there are a plurality of weight coefficients Wj and the second embodiment is more advantageous in cases where the difference between the characteristic of the first state and the characteristic of the second state is identified based on information regarding the weight coefficients Wj as a part of an inference step as compared with cases where the difference in the characteristic between the first state and the second state based on the final output result (inference result) from the output layer 30 is identified.

Furthermore, in the second embodiment, in the learning of the weight coefficients Wj of the output layer 30 executed for obtaining the change in the function characteristic between the first state and the second state, the input information, as an input data set as a certain reference standard and a training data set corresponding to the input data set, may be used as the learning data.

Further, the training data set may be switched to one of a plurality of different training data sets. In this case, each of the different training data sets can be used for switching the scope or type of the function characteristic to be obtained.

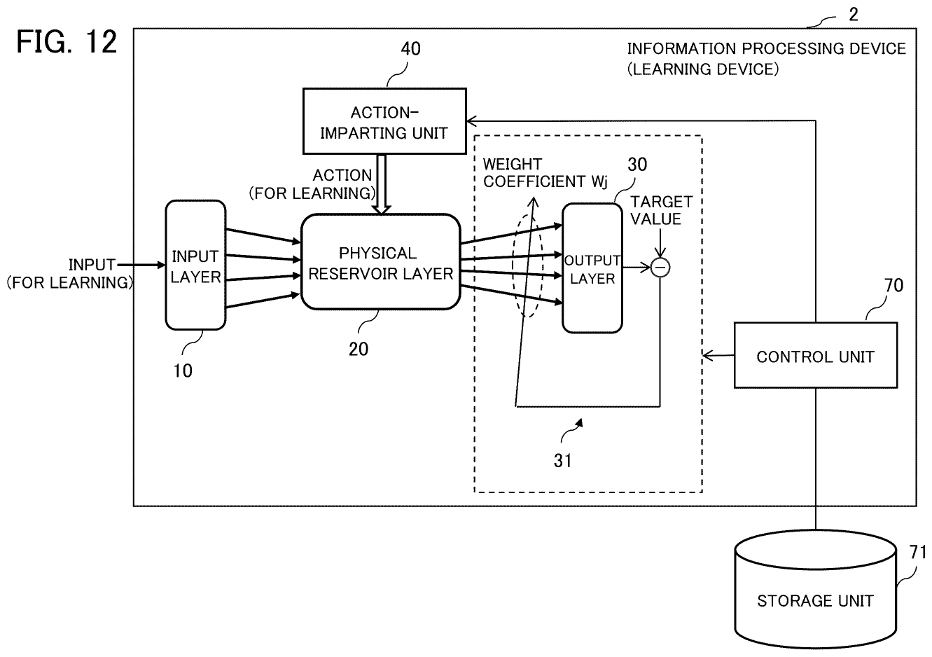

FIG. 12 is a functional block diagram showing the configuration of an information processing device 2 (learning device) according to the second embodiment. The information processing device 2 is a device capable of executing an information processing method (learning method) according to the second embodiment. A control unit 70 (learning control unit) of the information processing device 2 is a computer, for example.

The information processing device 2 includes the neural network that includes the input layer 10, the physical reservoir layer 20 as the intermediate layer, and the output layer 30, the action-imparting unit 40 that imparts an action to the physical reservoir layer 20, thereby causing a change corresponding to the imparted action to the internal connection state of the physical reservoir layer 20, the adjustment unit 31 that adjusts the weight coefficients Wj (j: positive integer assigned to each of a plurality of weight coefficients) of the output layer 30 based on the output value of the output layer 30, and the control unit 70 that controls the operation of the action-imparting unit 40. The information processing device 2 is connected to a storage unit 71 as a storage device for storing information. The storage unit 71 can also be a part of the information processing device 2.

The control unit 70 of the information processing device 2 generates a learning model, for inferring an inference result based on the weight coefficients Wj from the action imparted to the physical reservoir layer 20, by using learning data including learning action data and learning training data, and stores the weight coefficients Wj for each of the plurality of actions in the storage unit 71 as parameters of the learning model. The hardware configuration of the information processing device 2 is the same as that in the first embodiment.

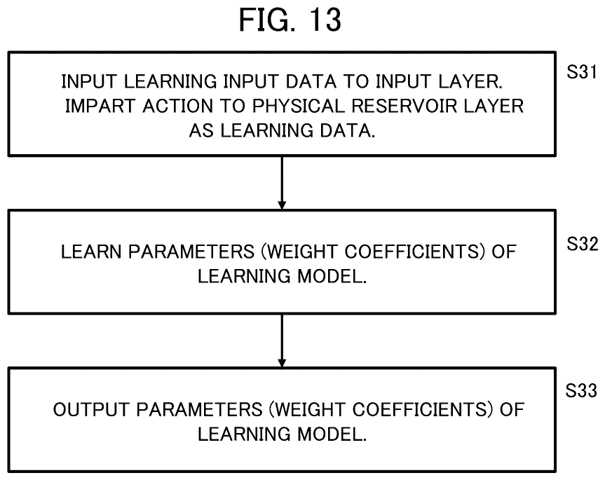

FIG. 13 is a flowchart showing a learning process of the information processing device 2 (learning device) according to the second embodiment. In the learning process of the information processing device 2, the learning input data is inputted to the input layer 10 and an action is imparted to the physical reservoir layer 20 as learning data (step S31), the weight coefficients Wj are learned as the parameters of the learning model (step S32), and the weight coefficients as the parameters are outputted (step S33). The outputted weight coefficients Wj are stored in the storage unit 71.

Further, there are cases where a learning model is used for magnifying the difference between two patterns that are difficult to distinguish from each other and transforming the two patterns to patterns easily distinguishable from each other. In such cases, it is possible to generate a learning model capable of determining whether inputted actions are the same as each other or not by setting the internal connection state of the physical reservoir layer 20 to the first state by imparting an action to the physical reservoir layer 20, executing the learning while changing the weight coefficients, acquiring a first weight coefficient group Wg1, setting the internal connection state of the physical reservoir layer 20 to the second state by imparting another action to the physical reservoir layer 20, executing the learning while changing the weight coefficients, acquiring a second weight coefficient group Wg2, and comparing the first weight coefficient group Wg1 and the second weight coefficient group Wg2.

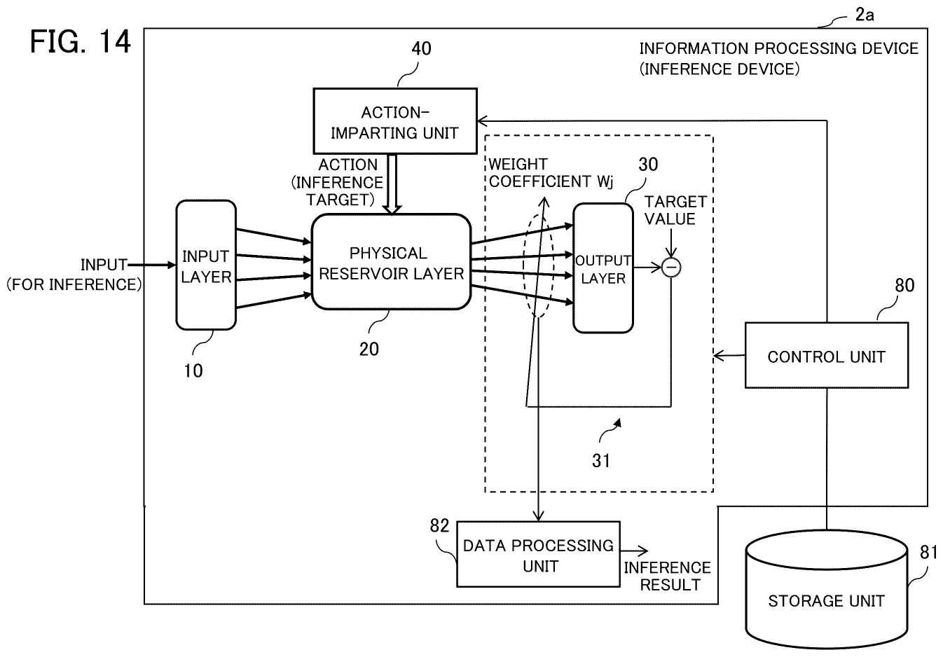

FIG. 14 is a functional block diagram showing the configuration of an information processing device 2a (inference device) according to the second embodiment. The information processing device 2a is a device capable of executing an information processing method (inference method) according to the second embodiment. A control unit 60 (inference control unit) of the information processing device 2a is a computer, for example. The control unit 80 of the information processing device 2a infers the output value as the inference result made up of the weight coefficients from the action as the inference target by using a learning model corresponding to the action imparted by the action-imparting unit 40. A data processing unit 82 outputs the inference result from the weight coefficients. The inference result is stored in a storage unit 81. While the storage unit 81 stores the learning model in the storage unit 71 in FIG. 12, the storage unit 81 can be the same unit as the storage unit 71. The data processing unit 82 is capable of calculating an action level that represents intensity of the action imparted to the physical reservoir layer based on the difference between a first weight coefficient as the weight coefficient when the internal connection state of the physical reservoir layer 20 is the first state and a second weight coefficient as the weight coefficient when the internal connection state of the physical reservoir layer is the second state different from the first state.

Further, the control unit 60 may also select a learning model corresponding to the action imparted by the action-imparting unit 40 from learning models for inferring the output value from the input information inputted to the input layer 10 generated by a learning device that uses learning data including learning input data and learning training data and infer the output value as the inference result outputted from the output layer 30 from the input information regarding the inference target inputted to the input layer 10 by using the selected learning model. In this case, the information processing device 1a is a learning-inference device.

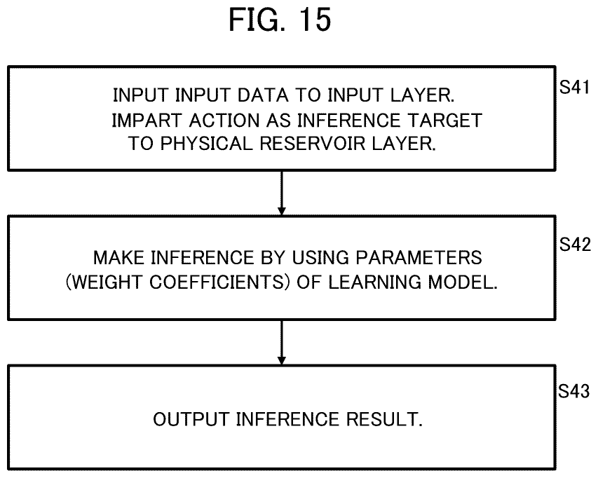

FIG. 15 is a flowchart showing the inference process of the information processing device 2a (inference device) according to the second embodiment. In the inference process of the information processing device 2a, input data is inputted to the input layer 10 and an action as the inference target is imparted to the physical reservoir layer 20 (step S41), the inference is made by using the parameters (weight coefficients) of the learning model (step S42), and the inference result is outputted (step S43).

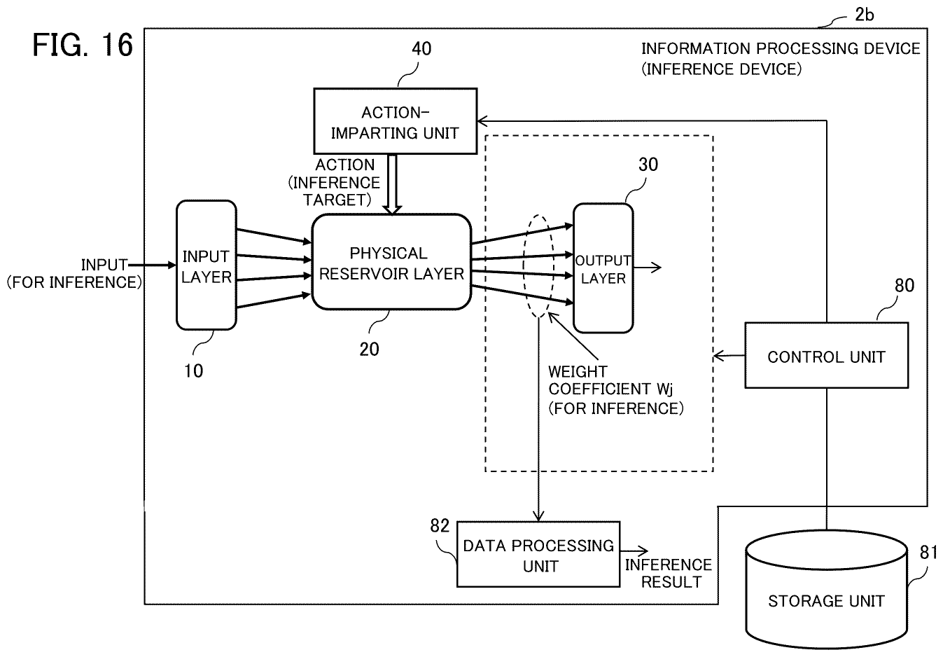

FIG. 16 is a functional block diagram showing another configuration of an information processing device 2b (inference device) according to the second embodiment. In this case, the control unit 80 updates the learning model based on the action imparted by the action-imparting unit 40 and the inference result, without the need of updating the weight coefficients Wj of the output layer 30 so that an output value closest to the target value is obtained.

As described above, with the information processing devices 2, 2a and 2b based on the physical reservoir computing, it becomes possible to deal with various learning processes and inference processes by designating the action as the inference target. Further, with the information processing devices 2, 2a and 2b, high-sensitivity sensing based on the physical reservoir computing becomes possible.

Incidentally, the information processing devices in the above-described first and second embodiments and their modifications (hereinafter referred to simply as “above-described embodiments”) may be modified appropriately. For example, modification, addition or removal of a component can be made in regard to the physical reservoir layer 20 and the action-imparting unit 40 in the above-described embodiments. Further, features or components of the above-described embodiments may be appropriately combined together in a mode different from the above-described modes.

### DESCRIPTION OF REFERENCE CHARACTERS

1, 2: information processing device (learning device), 1a, 1b, 2a, 2b: information processing device (inference device), 10: input layer, 20: physical reservoir layer (intermediate layer), 30: output layer, 40: action-imparting unit, 50, 70: control unit (learning control unit), 51, 71: storage unit, 60, 80: control unit (inference control unit), 61, 81: storage unit, Wj: weight coefficient.

1. An information processing device comprising:
a neural network including at least an input layer, a physical reservoir layer as an intermediate layer, and an output layer;
an action-imparting unit to impart an action to the physical reservoir layer; and
processing circuitry
to adjust weight coefficients of the output layer based on an output value of the output layer; and
to control operation of the action-imparting unit.

2. The information processing device according to claim 1, wherein the processing circuitry
generates a learning model, for inferring the output value from input information inputted to the input layer, by using learning data including learning input data and learning training data, and
stores the weight coefficients for a plurality of actions in a storage unit as parameters of the learning model.

3. The information processing device according to claim 2, wherein the processing circuitry infers the output value as an inference result outputted from the output layer from the input information regarding an inference target inputted to the input layer by using the learning model corresponding to the action imparted by the action-imparting unit.

4. The information processing device according to claim 3, wherein the processing circuitry updates the learning model by using the input information and the output value.

5. The information processing device according to claim 1, wherein the processing circuitry
selects a learning model corresponding to the action imparted by the action-imparting unit from learning models for inferring the output value from input information inputted to the input layer generated by a learning device that uses learning data including learning input data and learning training data, and
infers the output value as an inference result outputted from the output layer from the input information regarding an inference target inputted to the input layer by using the selected learning model.

6. The information processing device according to claim 1, wherein the processing circuitry
generates a learning model, for inferring an inference result based on the weight coefficients from the action imparted to the physical reservoir layer, by using learning data including learning action data and learning training data, and
stores the weight coefficients for a plurality of actions in a storage unit as parameters of the learning model.

7. The information processing device according to claim 6, wherein the processing circuitry infers the inference result based on the weight coefficients from the action imparted by the action-imparting unit by using the learning model.

8. The information processing device according to claim 7, wherein the processing circuitry updates the learning model based on the action imparted by the action-imparting unit and the inference result.

9. The information processing device according to claim 1, wherein the processing circuitry
selects a learning model corresponding to the action imparted by the action-imparting unit from learning models for inferring an inference result based on the weight coefficients from the action imparted to the physical reservoir layer generated by a learning device that uses learning data including learning action data and learning training data, and
infers the inference result based on the weight coefficients from the action imparted by the action-imparting unit by using the selected learning model.

10. The information processing device according to claim 1, wherein
the physical reservoir layer includes an optical internal connection state as a component of the neural network, and
the internal connection state changes due to the action including an optical factor imparted to the physical reservoir layer.

11. The information processing device according to claim 10, wherein
speckle light is inputted from the input layer to the physical reservoir layer, and
the physical reservoir layer generates intermediate light of the speckle light by repeating scattering and diffusion of light inside the layer.

12. The information processing device according to claim 1, wherein the action includes at least one factor selected from the group consisting of light, electricity, magnetism, heat, external force and a chemical substance imparted to the physical reservoir layer.

13. The information processing device according to claim 1, wherein a change of the internal connection state of the physical reservoir layer varies depending on the physical reservoir layer's region to which the action is imparted.

14. The information processing device according to claim 1, wherein the action is imparted to a part of the physical reservoir layer's region.

15. The information processing device according to claim 1, wherein the processing circuitry calculates an action level that represents intensity of the action imparted to the physical reservoir layer based on difference between a first weight coefficient as the weight coefficient when the internal connection state of the physical reservoir layer is a first state and a second weight coefficient as the weight coefficient when the internal connection state of the physical reservoir layer is a second state different from the first state.

16. An information processing method to be executed by an information processing device that includes
a neural network including at least an input layer, a physical reservoir layer as an intermediate layer, and an output layer; and
an action-imparting unit to impart an action to the physical reservoir layer, the information processing method comprising:
adjusting weight coefficients of the output layer based on an output value of the output layer; and
making the action-imparting unit impart an action to the physical reservoir layer.

17. A non-transitory computer-readable record medium recording an information processing program, the program causing a computer that includes a neural network including at least an input layer, a physical reservoir layer as an intermediate layer, and an output layer; and an action-imparting unit to impart an action to the physical reservoir layer, to execute:
adjusting weight coefficients of the output layer based on an output value of the output layer; and
making the action-imparting unit impart an action to the physical reservoir layer.

18. An information processing device according to claim 1, wherein the action-imparting unit causes a change corresponding to the action to an internal connection state of the physical reservoir layer.
